(19) United States
(12) Patent Application Publication
(10) Pub. No.: US 2026/0037523 A1
(43) Pub. Date: Feb. 5, 2026

(54) ADAPTIVE INFORMATION RETRIEVAL UTILIZING SEMANTIC AND LEXICAL SCORING

(71) Applicant: Intuit Inc., Mountain View, CA (US)

(72) Inventors: Siddharth JAIN, Mountain View, CA (US); Sivashanker THIRUCHITTAMPALAM, Toronto (CA); Jonathan LIN, Gloucester (CA); Venkat Narayan VEDAM, Mountain View, CA (US)

(21) Appl. No.: 18/791,185

(22) Filed: Jul. 31, 2024

(51) Int. Cl. G06F 16/2457; G06F 16/93

(52) U.S. Cl. CPC G06F 16/24578; G06F 16/93

(57) ABSTRACT

Certain aspects of the disclosure provide a method of adaptive information retrieval based on both lexical and semantic relevance. In some aspects, the method includes identifying a plurality of documents based on a context of the query request, assigning an integrated score for each respective document of the plurality of documents based on a semantic score for the respective document and a lexical score for the respective document, and ranking each document of the plurality of documents based on the integrated score.

### BACKGROUND

### Field

Aspects of the present disclosure relate to adaptive information retrieval, in particular, to adaptive information retrieval based on semantic and lexical scoring.

### Description of Related Art

Information retrieval is the process of identifying and retrieving information, including documents or other data stored in large data repositories. An information retrieval system allows users to communicate with the system in order to find information-text, graphic images, sound recordings, video, etc. that meet their specific needs. For example, the objective of a text information retrieval system may be to enable users to find information from an organized collection of documents that is relevant to answer a query, where a query is a question or a request for such information.

Search engines, such as Google® and Bing®, as well as other searching tools including Expedia® (e.g., flight searching tool) and/or LinkedIn® (e.g., job searching tool), are commonly used information retrieval systems. Users enter a search query, often comprising keywords or search terms, into the search engine. The search engine searches a data repository, for example, the Internet, to analyze and rank websites based on relevancy to the search query.

One way to determine relevance of data to a search term is through a lexical search. In a lexical search, keywords and terms in a search query are matched to keywords and terms from the data repository. In an internet search engine, the search query terms are matched to keywords and terms on websites. In a document retrieval example, the search query terms are matched to keywords and terms within a document.

One problem with a lexical search is that the lexical search identifies matching of exact terms, but without the context of the terms. Specifically, natural language may be troublesome for a term-based search due to homographs, that is, a word with two or more meanings. For example, a search for a “bow” may return results related to a stringed weapon, a hair accessory, and the front of a ship. Other linguistic quirks may similarly result in nonsensical or irrelevant search results. For example, euphuisms, figures of speech, slang, or idioms in a search query may achieve poor search results. Other times, a search query might not contain an exact keyword or term, for example, by using implication to search, misspelling of a term, or misuse of a term. For example, rather than searching using the term “onomatopoeia”, a search query may search for “animal sounds” without using a key term, use a misspelled term “On a Mona Pia”, or use an incorrect term “homophone”.

One method for improving search is to utilize the user's intent and context of search terms through semantic understanding of a search query. For example, a semantic search for a “bow for Olympic archery” would obtain results related to recurve bows, while a search for “bow for long hair” would obtain results related to hair bows. Semantic search, however, requires natural language processing (NLP) of a search query through complex algorithms or machine learning models. Accurate models require extensive training and maintenance, while also being slower compared to simpler lexical searching.

Accordingly, there is a need for improved information retrieval systems.

### SUMMARY

Certain aspects provide a method of adaptive information retrieval, comprising: receiving, a query request for document retrieval; identifying a plurality of documents based on a context of the query request, comprising: assigning a semantic score to each document of the plurality of documents based on a semantic relevance between the query request and each respective document; and assigning a lexical score to each document of the plurality of documents based on a lexical relevance between the query request and each respective document; assigning an integrated score for each respective document of the plurality of documents based on the semantic score for the respective document and the lexical score for the respective document; and ranking each document of the plurality of documents based on the integrated score.

Certain aspects provide a method of adaptive information retrieval, comprising: receiving, a relevancy search request for document retrieval to augment a prompt to a large language model (LLM); identifying a plurality of documents based on a context of the relevancy search request, comprising: assigning a semantic score to each document of the plurality of documents based on a semantic relevance between the relevancy search request and each respective document; and assigning a lexical score to each document of the plurality of documents based on a lexical relevance between the relevancy search request and each respective document; assigning an integrated score for each respective document of the plurality of documents based on the semantic score for the respective document and the lexical score for the respective document; ranking each document of the plurality of documents based on the integrated score; and providing one or more of the plurality of documents to the LLM with the prompt based on the ranking.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example adaptive information retrieval system.

FIG. 2 depicts an example process for adaptive information retrieval.

FIG. 3 depicts an example retrieval-augmented generation process.

FIG. 4 depicts an example process for generating and using a vector index.

FIG. 5 depicts an example process for generating and using an inverted index.

FIG. 6 depicts an example method for adaptive information retrieval.

FIG. 7 depicts an example method for adaptive information retrieval for retrieval-augmented generation processes.

FIG. 8 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for adaptive information retrieval based on semantic and lexical scoring.

Some information retrieval systems seek to combine semantic and lexical searches. These systems rely on static combinations of each type of search, for example, an equal combination of each, a primary match reliance on semantic relevance or a primary reliance on a lexical match. However, such systems do not dynamically adapt and adjust based on the context of the query. For example, a system primarily relying on a lexical match may retrieve a variety of disjointed results, such as the search for a “bow” described above, which may return results related to a stringed weapon, a hair accessory, and the front of a ship. As another example, a system primarily relying a semantic match may be ineffective in searching tabular data because the structure of data may impart context to the data, which the semantic search may not consider. Thus, such systems have reduced performance and effectiveness in obtaining relevant search results. Further, such systems cannot be adapted to account for the different types of data available for searching, for example, tabular data or structured documents.

Moreover, when an information retrieval system is integrated with other systems and components, for example, utilized as part of a large language model through retrieval-augmented generation (RAG), or other downstream processes, incomplete, incorrect, or ambiguous search results may be amplified. For example, a chat bot relying on a limited or erroneous information retrieval system may give an erroneous response to a user query.

Embodiments of the present disclosure provide technical solutions to overcome these technical limitations of conventional information retrieval systems and methods. Certain embodiments provide for generation of an integrated score based on both semantic relevance and lexical relevance of a result (e.g., a text document) and the impact of the semantic relevance and the lexical relevance of a result on the integrated score is adjustable. In some embodiments, the information retrieval system may increase the influence of semantic relevance on the integrated score, whereby results with higher semantic relevance have a higher integrated score and results with higher semantic relevance are retrieved. In some embodiments, the information retrieval system may adapt to increase the influence of lexical relevance on the integrated score, whereby results with higher lexical relevance have a higher integrated score and are retrieved.

Embodiments described herein utilize a semantic search component configured to operate in a semantic vector space to understand and interpret the conceptual and contextual nuances of a user query. The semantic content of various documents and data are embedded in the semantic vector space enabling determination of semantic relevance between the context of a document and the context of the user query. Beneficially, complex user queries requiring understanding of concepts and relationships between concepts can be answered through the semantic search component.

Embodiments described herein further utilize a lexical search component configured to match keywords of a user query to keywords in a document corpus, also referred to as lexical search. The lexical search component benefits from the efficiency and speed of keyword matching in generating search results. Further, lexical search utilizes search intent (also referred to as keyword intent or user intent), which is the goal of the user when searching, to find relevant search results. Search intent may include navigational search intent, in which a user knows what they are looking for and want to obtain that result, for example, a user searching for a specific GitHub page. Another type of search intent is transactional intent in which a user wants to complete a specific action, for example, download software. One more type of search intent is an informational search intent in which a user is seeking information, for example, a user query how to train a model using unsupervised learning. In such cases, specific search terms, e.g., keywords used in the user query, may be critical to obtaining meaningful search results, and as such, search results with higher lexical relevance may be beneficially obtained.

Moreover, embodiments described herein provide for an integrated score based on both the semantic search results and the lexical search results to complement one another and provide lexically precise and conceptually relevant search results for the user query. Further, the integrated score is dynamically adaptable to impart increased reliance on semantic results or lexical results based on the context of the user query. For example, the integrated score may be adjusted based on additional data related to the user and/or the information retrieval system, such as previous queries, user attributes, domain-specific systems, and the like associated with the user and/or the system to promote increased contextual relevance or lexical accuracy of the integrated score. Thus, the information retrieval systems described herein provide improved search results with greater relevance to user queries.

Additionally, embodiments described herein utilize the information retrieval systems and methods described herein to supplement large language model (LLM) response generation, for example, as part of a RAG-based system.

An LLM is a type of machine learning (ML) model that supports natural language processing tasks. An LLM may be configured to generate text, analyze sentiment, answer prompts (e.g., specific instructions and/or requests) in a conversational manner, translate text from one language to another, summarize content, and/or the like. LLMs make it possible for software to “understand” typical human speech or written content, and respond to it. In some cases, an LLM may be used to retrieve information and provide it in a conversational manner.

One example of an LLM is a generative pre-trained transformer (GPT) models are a specific type of LLM based on a transformer architecture (e.g., architecture that uses an encoder-decoder structure and does not rely on recurrence and/or convolutions to generate an output), pre-trained in a generative and unsupervised manner (e.g., it learns from data without being given explicit instructions on what to learn). GPT models analyze prompts and predict the best possible responses based on their understanding of the language.

Generally, an LLM is trained on a large amount of data, for example, a general-purpose LLM (e.g., off-the-shelf LLM) is trained on publicly-available data, and may not be able to respond, or may respond incorrectly, to a domain-specific prompt, such as a prompt requesting information about employee retention at a particular company for a previous year, a prompt requesting customer help with an application and/or system internal to a company, and/or the like. The generalized LLM may not be able to respond or may respond incorrectly given the information that is requested is not part of the publicly available training data used to pre-train the LLM.

One method to improve the performance of an LLM is to provide additional data to the LLM to supplement the information available to the LLM to generate the response. Thus, the LLM may beneficially generate a response, or generate a correct response. In particular, the RAG method supplements the information available to the LLM to generate the response. The LLM will be able to utilize external data, that is, data that is not part of the training data used to train the LLM, in generating the response. External data may be in a database, document repository, or otherwise available through an API. Beneficially the external data may provide domain-specific information, for example, information related to a specific application, an internal system, or a domain-knowledge database, for use by the LLM in generating a response.

For example, a RAG system may be designed with a retrieval component and a generative component. The retrieval-based component may retrieve relevant documents, passages, and/or text from a data repository and/or corpus based on receiving an input query. The retrieved documents, passages, and/or text may be concatenated as context with the original input query and fed to the generative component (e.g., a text generator) of the RAG system, which in turn produces text output for the input query. By combining the input query with the contextual documents, the LLM receives a comprehensive input that incorporates both the user's query and the relevant information from external sources. This method helps to reduce the risk of generating irrelevant responses, as well as improves the overall accuracy and/or relevance of the response. Thus, the LLM's performance may be improved because the LLM has additional data to utilize in generating the response.

However, LLMs have a limit to the volume of data, which may be inputted as the query, called a token limit. Thus, a technical limitation of LLMs is that the additional data provided to supplement the input query may improve the LLM's performance in generating an output; however, there is a limit to the volume of additional data used to supplement the initial query. Therefore, the retrieval-based component needs to obtain highly relevant, yet concise additional data.

Aspects of the adaptive information retrieval system described herein technical solutions and improvements of RAG methods by utilizing the improved information retrieval methods described herein to identify and obtain relevant additional data through the retrieval-based component of the LLM, and enhance generating of the output.

The LLM's performance may be improved through utilization of such supplemental data. Thus, embodiments described herein enable improved LLM responses and performance through improved information retrieval systems and methods to obtain such supplemental data for an LLM.

### Example System for Interacting with and Utilizing an Information Retrieval System

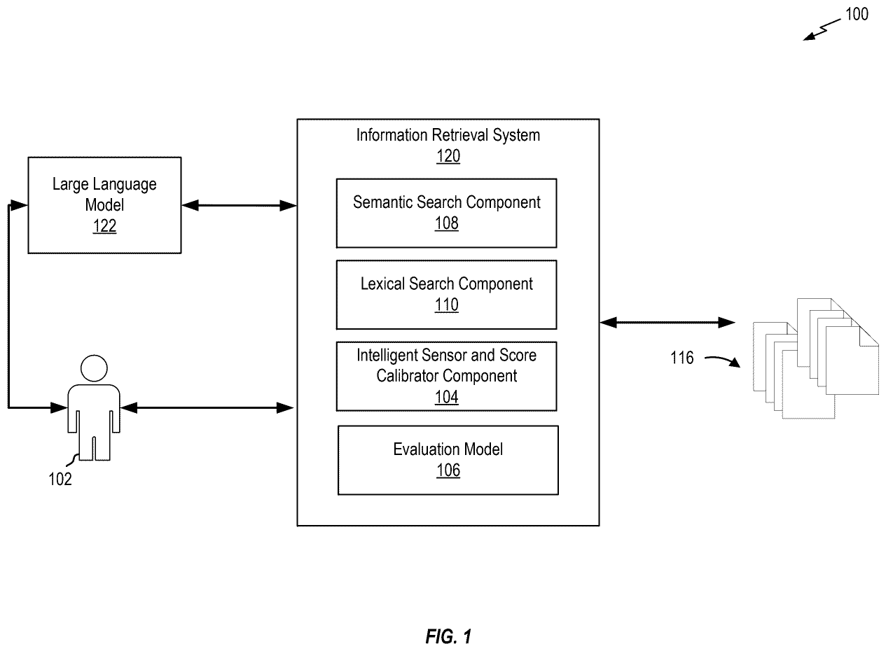

FIG. 1 depicts an example system 100 for interacting with and utilizing an information retrieval system 120 to identify and retrieve semantically and lexically relevant information. The information retrieval system 120 is configured to adaptively retrieve information, in this example, information associated with one or more documents stored in a document repository 116. In some examples, such information may be associated with webpages, tabular data sets, graphic images, sound recordings, videos, and the like.

In some embodiments, the information retrieval system 120 is configured to retrieve information based on a search request from a user 102. A search request is a query seeking information, for example, seeking to find a specific document or webpage, seeking information about a topic, seeking to accomplish a task, and the like. Generally, a search request is in the form of natural language text. In some embodiments, a search request may be converted to text, for example, a voice-to-text feature.

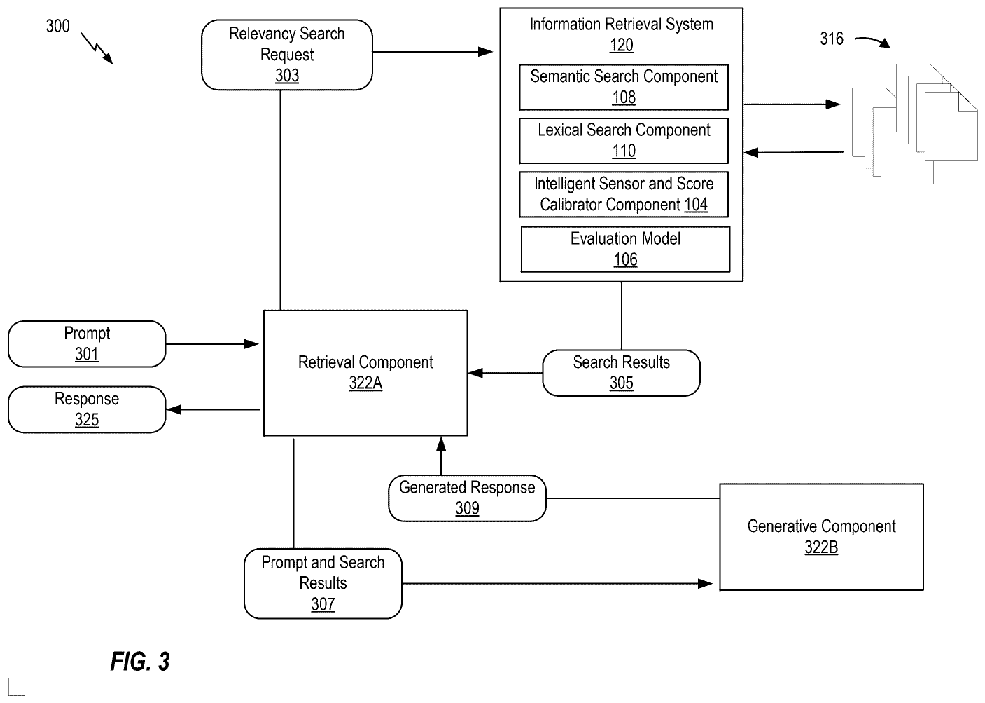

In some embodiments, the information retrieval system 120 is configured to retrieve information based on a relevancy search request from an LLM 122, for example, through RAG, as described below with respect to FIG. 3.

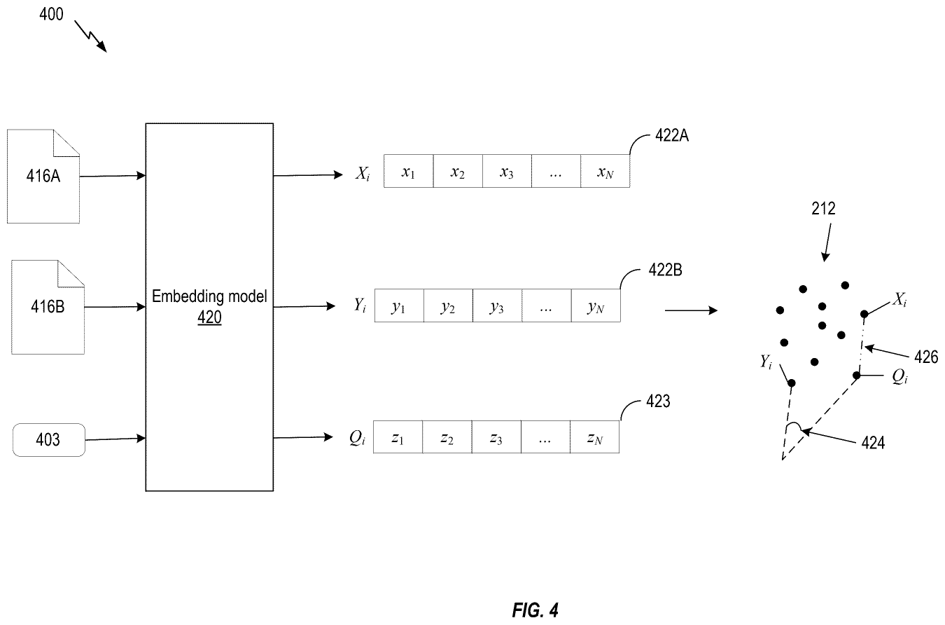

The information retrieval system 120 further comprises a semantic search component 108. The semantic search component 108 is configured to understand and interpret the conceptual and contextual nuances of search requests. The semantic search component 108 is further configured to analyze the semantic content of documents to find matches that are contractually similar to the search request. Beneficially, the semantic search component 108 handles complex search requests, for example, natural language queries, requiring a deep understanding of topics and relationships between concepts. The semantic search component 108 is configured to utilize a semantic vector space, using embedding models such as text-ada-002, SFR-Embedding-Mistral, jina, and the like, to embed various information from the document repository 116 and identify semantically relevant information from the document repository 116. Semantic vector spaces and embeddings are further described with respect to FIG. 4.

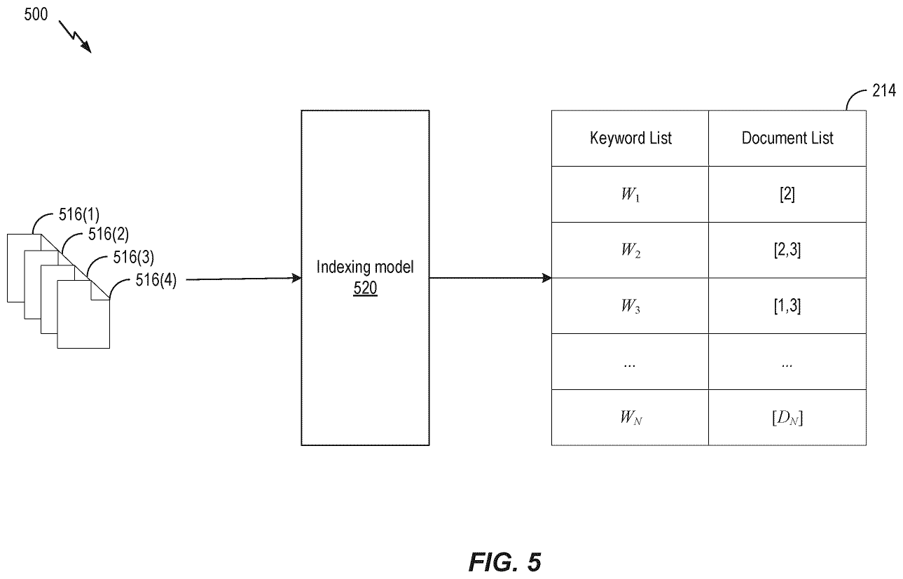

The information retrieval system 120 comprises a lexical search component 110. The lexical search component 110 is configured to utilize an inverted index structure to efficiently keyword match a search request with keywords in the document repository 116. The lexical search component 110 is configured to quickly and efficiently retrieve information from the document repository 116. Further, the lexical search component 110 is configured to complement the semantic search component 108 in retrieving information by identifying results based on the specific terms critical to search intent. Lexical searching and the inverted index structure are further described with respect to FIG. 5.

The information retrieval system 120 comprises an intelligent sensor and score calibrator component 104. The intelligent sensor and score calibrator component 104 is configured to utilize the output of the semantic search component 108 and the lexical search component 110 to generate an integrated score based on results from both the semantic search component 108 and the lexical search component 110. In some embodiments, the intelligent sensor and score calibrator component 104 utilizes one or more neural network models that combine static features with time series or dynamic features with respect to model training and inferencing. The intelligent sensor and score calibrator component 104 is further configured to dynamically adjust the influence of the semantic search component 108 or the lexical search component 110 on the integrated score. For example, the intelligent sensor and score calibrator component 104 adjusts the influence of the semantic search component 108 output to impact the semantic relevance of the integrated score. The intelligence sensor and score calibrator component 104 may adjust the influence of the lexical search component to affect the lexical relevance of the integrated score.

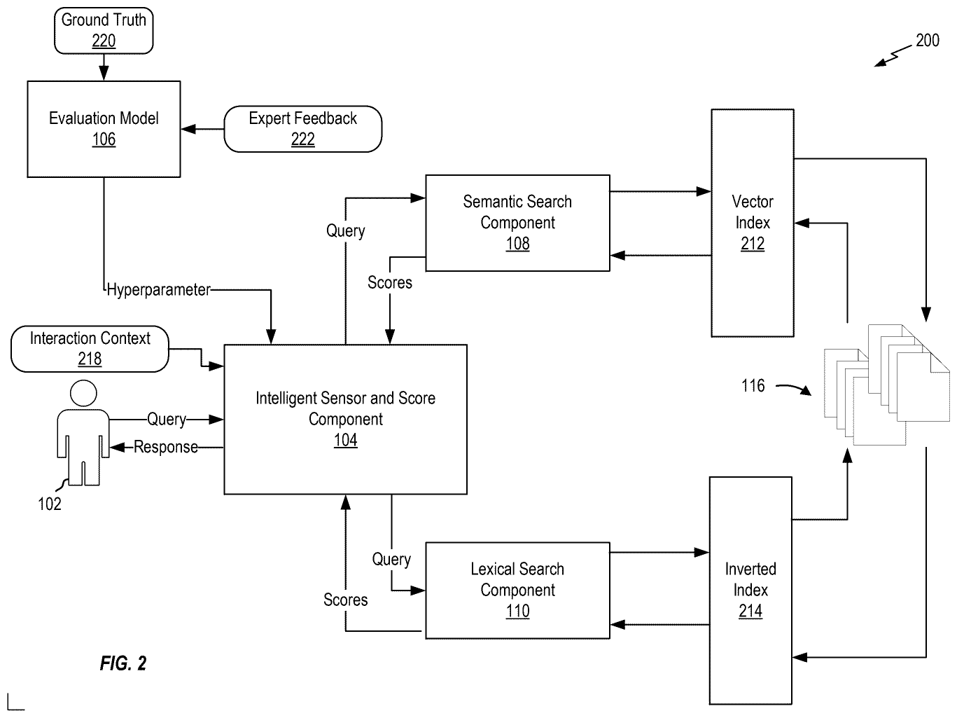

The information retrieval system 120 further comprises an evaluation model 106. The evaluation model 106 is configured to dynamically determine the influence of the semantic search and the lexical search on the search results to be used by the intelligent sensor and score calibrator component 104. Determining and utilizing the hyperparameters to dynamically adapt the integrated score is discussed further with respect to FIG. 2.

Beneficially, the information retrieval system 120 is configured to utilize the evaluation model 106 to adjust the integrated score based on both the semantic search results and the lexical search results to complement one another and provide lexically precise and conceptually relevant search results for the user query. For example, the integrated score may be dynamically adapted to impart increased reliance on semantic results (e.g., from semantic search component 108) or lexical results (e.g., from lexical search component 110) based on the context of the user query. In some embodiments, beneficially, the integrated score may be adjusted based on additional data related to the user and/or the information retrieval system, such as previous queries, user attributes, domain-specific systems, and the like associated with the user and/or the system to promote increased contextual relevance or lexical accuracy of the integrated score. Thus, the information retrieval systems described herein provide improved search results with greater relevance to user queries.

### Example Flow for Searching with the Information Retrieval System

FIG. 2 depicts an example process 200 for searching with an information retrieval system, for example, information retrieval system 120 in FIG. 1.

Initially, a user 102 sends a query to the intelligent sensor and score calibrator component 104. intelligent sensor and score calibrator component 104 intelligent sensor and score calibrator component In some embodiments, the user 102 indirectly sends a query to the intelligent sensor and score calibrator component 104, for example, through a search engine, a knowledge engine, LLM (such as LLM 122 in FIG. 1), etc. In some embodiments, the process 200 is performed by a search engine, for example, to facilitate responses to a search query. In some embodiments, the process 200 is performed by a knowledge engine, for example, to facilitate responses based on a knowledge database. In some embodiments, the process 200 is performed in response to a request from another service, for example, retrieve data for models, data analysis, in response to an application programming interface (API), and the like.

The intelligent sensor and score calibrator component 104 sends the query to a semantic search component 108. The semantic search component 108 may be an example of the semantic search component 108 in FIG. 1. The semantic search component 108 is configured to semantically search a document repository 116, which are embedded in a vector index 212 to identify one or more semantically relevant documents in the document repository 116. The semantic search component 108 identifies relevant documents by assigning a semantic score based on a semantic relevance between the search query and each document.

FIG. 4 depicts an example process 400 for assigning a semantic score based on the semantic relevance between a search query and two documents. In the depicted example, a first document 416A is embedded in the vector index 212 by an embedding model 420. In some embodiments, the embedding model may be a text-ada-002 embedding model, a SFR-Embedding-Mistral Model, a jina embedding model, and the like. For example, the embedding model 420 is a bidirectional encoder representations from transformers (BERT) model.

In particular, the embedding model 420 is configured to convert text data to a numerical representation which may be projected into a high-dimensional latent space (also called an embedding space) of the vector index 212. The embedding model 420 is configured to chunk the first document 416A into semantic units, for example, words, sub-words, phrases, and the like, and embed each semantic unit into the embedding space as a vector. The resulting first vector 422A contains numerical entries denoted by Xᵢ, where i=1, . . . , N, and represents a point in an N-dimensional space. The resulting first vector Xᵢ corresponds to a point in the vector index 212. In the depicted example only two dimensions are visualized, e.g., points in N=2 dimensions. One or more additional documents may similarly be embedded in the embedding space as vectors. In this example, a second document 416B is converted to a second vector 422B containing numerical entries denoted by Yᵢ, where i=1, . . . , N, and represents a point in an N-dimensional space.

During the semantic search by the semantic search component 108 in FIG. 2, the semantic relevance is determined based on the relevance between an embedded vector representing the query and other embedded vectors, each of which represents a document or portion of a document (e.g., the first document 416A or the second document 416B). The query, in FIG. 4 query 403, is also embedded by embedding model 420 as a query vector 423 containing numerical entries denoted by Qᵢ, where i=1, . . . , N, and represents a point in an N-dimensional space.

The semantic relevance between the query vector Qᵢ and other vectors may be determined based on the similarity or distance between the query vector Qᵢ and each other vector. For example, the semantic relevance may be determined based on cosine similarity. The cosine similarity ranges between −1 and 1 and measures the degree of similarity between two vectors in an N-dimensional space, in this example, represented as cosine similarity 424 between second vector Yᵢ and the query vector Qᵢ. The closer the cosine similarity 424 is to “1”, the more semantically similar the second document 416B and the query. The cosine similarity may be used for comparing similarity of content of documents or sentences. This is because the cosine similarity ignores magnitude differences between the query and the embedded vector. Further, the cosine similarity may be less computationally expensive. Thus, in some embodiments, the cosine similarity may be used based on the type of content of a document and/or the query.

As another example, the semantic relevance may be determined based on Euclidean distance. The Euclidean distance is the length of a line segment between two points. The closer the two points are, the shorter the Euclidean distance between them. Thus, the Euclidean distance indicates similarity between two embedded vectors, in this example, represented as distance 426 between the query vector Qᵢ and the first vector Xᵢ. A lower, or shorter, distance indicates an increased semantic similarity between the query and the first document 416A. The Euclidean distance may be used for comparing overall length and word usage patterns between a document and the query. This is because Euclidean distance utilizes absolute magnitude differences in determining similarity. Moreover, the Euclidean distance may be more computationally expensive compared to other methods. Thus, in some embodiments, the Euclidean distance may be used based on the type of content of a document and/or the query. The semantic relevance between each document and the query may be indicated as a semantic score.

Returning to FIG. 2, the intelligent sensor and score calibrator component 104 also sends the query to a lexical search component 110. The lexical search component 110 may be an example of the lexical search component 110 in FIG. 1. The lexical search component 110 is configured to lexically search the document repository 116, which documents are embedded in an inverted index 214 to identify one or more lexically relevant documents in the document repository 116. The lexical search component 110 identifies relevant documents by assigning a lexical score based on the lexical relevance between the search query and each document.

FIG. 5 depicts an example process 500 for generating and using an inverted index 214 to obtain a lexical score based on the lexical relevance between a search query and two documents. An inverted index is a database index mapping content to its location in a document, or set of documents (e.g., in the document repository 116). In the depicted example, a set of documents 516 comprises four documents, first document 516(1), second document 516(2), third document 516(3), and fourth document 516(4). An indexing model 520 generates the inverted index 214 by mapping each word in the keyword list, denoted by Wᵢ, where i=1, . . . , n and represents the n number of words in the corpus of the set of documents 516, to its location in the documents in the set of documents 516. For example, W₁ represents a first word indexed from the set of documents 516 and W₁ is found in the second document. As another example, W₂ represents a second word indexed from the set of documents 516 and W₂ is found in the second document and the third document. In yet another example, W₃ represents a third word indexed from the set of documents 516 and W₃ is found in the first document and the third document. This index repeats for each word Wᵢ in the set of documents 516.

During the lexical search by the lexical search component 110 in FIG. 2, the lexical score is determined based on keyword matches between the query and the keywords in the keyword list. For example, a keyword match between W₃ and a word in the search request indicates a relevance between the first document and the third document, with the search request. Various keyword searching and ranking algorithms may be used to determine keyword matches and rank the relevance of documents based on the keyword matches. Example ranking functions include BM25, an example bag-of-words retrieval function, and TF-IDF.

The lexical relevance between each document and the query may be indicated as a lexical score. A higher lexical score is assigned to the document(s) with a higher relevance (e.g., ranked higher); while a lower lexical score is assigned to the document(s) with a lower relevance (e.g., ranked lower).

Returning to FIG. 2, the intelligent sensor and score calibrator component 104 receives the semantic scores from the semantic search component 108 and the lexical scores from the lexical search component 110. The intelligent sensor and score calibrator component 104 is configured to generate an integrated score based on the semantic score and the lexical score for each document. In particular, the integrated score beneficially combines the semantic score and the lexical score while also accounting for divergences between the semantic search results and the lexical search results. The semantic search results account for the semantic context and structure of the text, e.g., of documents 216. The lexical search results account for the importance of terms within a corpus, e.g., within the corpus of documents in document repository 116.

In one example, the integrated score is determined as follows:

$$Integrated Score = \frac{( {( α \cdot {( semantic score + {b}_{smeantic} )}^{{w}_{semantic}} + ( 1 - α ) \cdot {( lexical score + {b}_{lexical} )}^{{w}_{lexical}} )}^{\frac{1}{p}} )}{( 1 + λ \cdot penalty )}$$

In the preceding formula, the a term is a weighted hyperparameter, which sets the balance between the contribution of the semantic score and the lexical score. If α is close to 1, the lexical score contributes more to the integrated score. Thus, where α=1, only the lexical score contributes to the integrated score. Whereas, if α is close to 0, semantic index contributes more to the integrated score. Thus, where α=0, only the semantic score contributes to the integrated score. The α term may be adjusted to adjust the balance between the semantic relevance and lexical relevance to the integrated score. Thereby, the search results may balance contextual relevance and lexical accuracy of search results to the query. The evaluation model 106 is configured to predict the a term based on the query. In embodiments, the evaluation model 106 optimizes the hyperparameters, e.g., the α term, or tunes the hyperparameters, to determine the optimal hyperparameters for the intelligent sensor and score calibrator component 104. The evaluation model 106 can be any type of machine learning model, such as, but not limited to, a neural network, decision tree, support vector machine, ensemble model, etc. In some embodiments, the evaluation model 106 is initially trained using a training dataset of user queries, e.g., the ground truths 220, and subject matter expert (SME) approved responses, e.g., as expert feedback 222, for example, using reinforcement learning to determine the hyperparameter setting that best aligns the search results with the ground truths 220 and expert feedback 222. Thus, the task is to identify a set of hyperparameters that results in the model with the generalization error on the validation set is minimized. During training, the hyperparameters are set at initial values, the reinforcement learning algorithms learn by taking actions to maximize a reward. Reinforcement learning is iterative in that the evaluation model learns as it explores possible states while exploiting, e.g., utilizing, those states which result in maximizing a reward. In particular, rather than trying every set of hyperparameters and evaluation each, in reinforcement learning, the evaluation model 106 navigates the hyperparameter space to determine the best configuration of hyperparameters by balancing exploiting already-explored hyperparameters with high-confidence, with exploring new hyperparameters with a potentially lower validation loss. By using a set of historical hyperparameter configurations and their associated rewards (e.g., based on the ground truths 220 and the expert feedback 222), the evaluation model 106 is trained to select the next hyperparameter setting to be evaluated in a way that maximizes the total reward within a limited budget.

In some embodiments, the evaluation model 106 may utilize Bayesian optimization to optimize the α term. Bayesian optimization uses a probabilistic model of the objective function, e.g., the model's performance for a set of hyperparameters, and then evaluates various sets of hyperparameters to determine the true objective function. The objective function indicates how well a set of hyperparameters perform on the set of hyperparameters. The goal is to maximize the objective function e.g., finding the true objective function by approximating the objective function and updating the approximate objective function as sets of hyperparameters are evaluated. For example, the evaluation model 106 evaluates the model's performance based on the ground truths 220 and the expert feedback 222 to determine the optimal set of hyperparameters.

Subsequently, in some embodiments, the α term may be dynamically tuned based on real-time user feedback, for example, based on direct user feedback or indirect user feedback. Direct user feedback includes user interactions directly stating the utility of the results, for example, a thumbs up or thumbs down on the results, a user comment, and the like. Indirect user feedback includes user interactions indirectly indicating the utility of the results, for example, clicking through the search results, leaving the system, sending a second query, dwell time on the search results, and the like. Both direct and indirect feedback may be utilized to dynamically tune the α term.

The bias terms, e.g., b_{semantic} and b_{lexcial} adjust the semantic score and the lexical score, respectively, to shift the baseline of the semantic score or the lexical score, to effectively handle edge cases or corpus-specific characteristics. For example, based on the type and/or content of the corpus of the documents to be searched, a bais of the semantic and/or lexical score may be adjusted. In some embodiments, the bias terms may be adjusted based on an index type and associated characteristics. For example, the document repository 116 may be semantics-heavy, e.g., significant natural language, and the b_{semantic} term may be increased to bias the integrated score towards the semantic score. In another example, the set of documents 116 may be lexical-heavy, e.g., lots of tabular data and/or keywords, the b_{lexcial} term may be increased to bias the integrated score towards the lexical score. In some embodiments, the bias terms may be adjusted based on interaction context 218. For example, an indication from a user for an increased reliance on semantic relevance or increased reliance on lexical relevance in generating the search results may be used to adjust bias terms. A user may select a contextual based approach to increase the bias of the semantic score (b_{semantic}), or a precise keyword search approach to increase the bias of the lexical score (b_{lexcial}), to tailor the search results.

The w_{semantic} term is weighting to control the semantic score. The w_{lexical} term is a weighting to control the lexical score. These weights dictate how sensitive the integrated score is to each respective score. For example, a w_{semantic} term>1 amplifies a higher semantic score, and similarly a w_{lexical} term>1 amplifies a higher lexical score. A w_{semantic} term<1 dampens a higher semantic score, and similarly a w_{lexical} term>1 dampens a higher lexical score.

The p parameter controls mean behavior. For example, where p=1, p is the arithmetic mean. As another example, where p=2, p is the quadratic mean. In some examples, the p parameter is the harmonic mean. The type of mean (e.g., arithmetic and/or quadratic) may be used based on the sensitivity and impact of an integrated score. For example, an arithmetic mean may be used in some embodiments to give an equal weighting to both the semantic term and the lexical term in the overall integrated score. As another example, a geometric mean may be used in some embodiments to emphasize a smaller score, thus increasing the weighting of the smaller score in the overall integrated score. As yet another example, a harmonic mean may be used in some embodiments to reduce the impact of an outlier score on the overall integrated score. In some embodiments, where p>1, the integrated score is more sensitive to larger values. In some embodiments, where p<1, the integrated score is more sensitive to smaller values. Thus, a higher p parameter may amplify a stronger and/or higher score, while a lower p parameter smooths the influence of a weaker and/or lower score.

The penalty term is a corrective term to adjust the composite score, based on divergence between the semantic score and the lexical score. The penalty term is calculated as follows:

$$penalty = - log P ( lexical , semantic )$$

where P(lexical, semantic) is the joint probability of lexical and semantic in a text segment pair, obtained through Kernel Density Estimation (KDE). KDE is the application of kernel smoothing for probability density estimation, e.g., a non-parametric method to estimate the probability density function of a random variable using kernels as weights. A kernel, such as a Gaussian kernel, is generally a positive function controlled by a bandwidth parameter, h. KDE works by creating a kernel density estimate, which may be represented as a curve or complex series of curves. In some embodiments, the kernel density estimate is calculated by weighting the distance of all the data points in each specific location along the distribution. If there are more data points grouped locally, the estimation is higher. The kernel function is the specific mechanism used to weigh the data points across the data set. The bandwidth, h, of the kernel acts as a smoothing parameter, controlling the tradeoff between bias and variance in the result. For example, a low value for bandwidth, h, may estimate density with a high variance, whereas a high value for bandwidth, h, may produce larger bias. Bias refers to the simplifying assumptions made to make a target function easier to approximate. Variance is the amount that the estimate of the target function will change, given different data.

The λ term scales the impact of the penalty term. A higher λ term means the penalty term has significant weight, affecting the composite similarly value drastically.

Thus, an integrated score may be determined for each document in the document repository 116. The integrated score indicates an overall relevance between the document and the search query, balancing both semantic relevance and lexical relevance. Moreover, because integrated score is adjustable, e.g., based on the α term, to increase the weight of the semantic score or the lexical score, and those dynamically adjust the semantic or lexical relevance of the search results. For example, a search query based on complex queries, such as, “How to get an oil stain out of clothing?” may be associated with increased semantic understanding of the topic and relationships between the concepts of the query, e.g., stain removers and laundry detergents, without using such terms. The integrated score may be adjusted, e.g., based on the α term, to increase the impact of the semantic score on the integrated score. Thus, search results with increased semantic relevance, e.g., a higher semantic score, will have a higher integrated score, indicating more relevance to the search query.

As another example, a search query based on specific terms or facts, such as, “What is the capital of France” may be associated with an increased lexical or keyword matching between the keywords of the query, e.g., “France” and “capital” to quickly obtain information. The integrated score may be adjusted, e.g., based on the α term, to increase the impact of the lexical score on the integrated score. Thus, search results with increased lexical relevance, e.g., a higher lexical score, will have a higher integrated score, indicating more relevance to the search query.

Search results may be ranked based on the integrated score, thereby, the search results reflect both semantic intent and lexical accuracy of the query. In some embodiments, the search results may be ranked by the highest integrated score to the lowest integrated score. Because the integrated score may dynamically adjust to impart a greater reliance on the semantic score or the lexical score, or, in some embodiments, a balance between the semantic score and the lexical score, the search results may be tailored to context and intent of the search query. Thus, in some embodiments, the search results may beneficially reflect enhanced semantic intent and/or lexical accuracy.

In some embodiments, the search results contain the top K documents, for example, the documents associated with the top 2, 5, 10 integrated scores. In some embodiments, the search results contain the documents associated with an integrated score satisfying a threshold, for example, documents associated with an integrated score greater than or equal to an integrated score threshold.

Note that FIG. 2 is just one example of a process, and other processes including fewer, additional, or alternative steps are possible consistent with this disclosure.

### Example Information Retrieval Process

FIG. 3 depicts an example information retrieval process 300 using an LLM and RAG, for example, using LLM 122 in FIG. 1. In some embodiments, the process 300 is performed by an LLM-based chatbot, for example, a question and answer LLM chatbot.

Initially, a prompt 301 is provided to a retrieval-based component 322A of an LLM, for example, part of the LLM 122 in FIG. 1. In some embodiments, the prompt 301 is provided by a user, for example, user 102 in FIG. 1. For example, a user may enter a question to a chatbot, a search query into a search engine, or a knowledge query into a knowledge engine. In some embodiments, the prompt 301 is provided by another service, for example, through an API or as a microservice. A microservice may be an independent service to segmented functionalities within a larger system infrastructure, for example, to facilitate downstream services and/or functionalities utilizing the information retrieved by an adaptive retrieval system.

The retrieval-based component 322A embeds the prompt 301 from text into a mathematical representation of the prompt. Further, the retrieval-based component 322A sends a relevancy search request to the information retrieval system 120 to obtain additional information to enhance the prompt 301.

The information retrieval system 120 may search the document repository 316 to determine documents and information relevant to the prompt 301, for example, as described with respect to process 200 in FIG. 2. In some embodiments, for example, the information retrieval system 120 is configured to obtain one or more search results 305 generated by the information retrieval system 120 include results relevant to both the semantic meaning, e.g., through the semantic search component 108, and the lexical meaning, e.g., through the lexical search component 110, of the prompt 301.

Moreover, the intelligent sensor and score calibrator component 104 is configured to combine the output of the semantic search component 108, a semantic score indicating the semantic relevance of a search result, and the output of the lexical search component 110, a lexical score indicating the lexical relevance of a search result to generate an integrated score for each search result. In some embodiments, the evaluation model 106 is configured to indicate an adjustment to the integrated score to impart greater emphasis on the semantic relevance or on the lexical relevance of the search results. In some embodiments, the evaluation model 106 is configured to indicate an adjustment to the integrated score to impart a balance between the semantic relevance and the lexical relevance of the search results. Thus, the reliance on semantic relevance or lexical relevance may be dynamically tuned to provide relevant search results. Beneficially, then, the search results obtained by the information retrieval system 120 provide a more enhanced context to augment the prompt 301.

In some embodiments, the number and/or size of documents in the search results may be associated with a context window of the generative component 322B. An LLM context window is associated with the size or volume of information that may be used to prompt an LLM to generate a response. Information not included in a context window may not be used by the LLM to generate the response. Thus, the number and/or size of search results provided to the generative component 322B may be limited to the context window. For example, in some embodiments, the search results are ranked based on the integrated score determined by the intelligent sensor and score calibrator component 104. In some embodiments, the top K ranked documents are provided to the retrieval-based component 322A to augment the prompt 301. For example, in some embodiments, the top 1, 2, 5, or 10 documents may be provided to the retrieval-based component 322A. In some embodiments, a portion of a document is provided to the retrieval-based component 322A to augment the prompt. The portion of the document may be based on a size of the document, for example, based on a number of tokens comprising the portion of the document. For example, the portion may be a set of R tokens of the document, such as the first 100 tokens, the first 1,000 tokens, the first 10,000 tokens, or the first 100,000 tokens. In some embodiments, the search results provided to the retrieval-based component 322A may be a portion of a number of documents, for example, a set of R tokens of the top K ranked documents. Thereby, the search results provided may be culled to reduce the size of the prompt and supplemental information to fit the context window, while also providing relevant search results.

The search results 305 are provided to the retrieval-based component 322A to supplement the prompt 301. Then, both the prompt and search results 307 are sent to the generative component 322B portion of the LLM. The generative component 322B is configured to generate a response 309 based on the prompt and the search results. The additional information provided in the search results 305 beneficially increased the available data for generating the response. For example, the prompt 301 may be domain-specific, such as related to internal documents. Without the search results 305, the LLM may generate a generic response, an incorrect response, or incomplete response. By providing the additional information retrieved through the information retrieval system 320, the LLM may generate a domain-specific response based on more complete information.

By way of example, a prompt (e.g., prompt 301) may be “What is the company's time off policy?” A generic (e.g., off-the-shelf) LLM utilizes training data to generate the response. For example, the LLM may generate a response, e.g., “The Company's paid time off is 12 weeks” based on publically available data, for example, job postings, job reviews, employment laws, etc. This response, however, may be incorrect, for example, based on a different company's data, or related to the company's parental leave policy.

By utilizing a RAG architecture and information retrieval system, (e.g., information retrieval system 320), the LLM is configured to utilize the additional data retrieved by the information retrieval system to generate a complete and accurate response. For example, the LLM may utilize the information retrieval system to search for documents pertaining to paid time off in the company's document database (e.g., document repository 316). The information retrieval system 320 may search for documents with both semantic and lexical relevance, for example, documents related to “paid time off” and documents related to “leave policies” to ensure relevant and complete information is retrieved. The information retrieval system may obtain search results including relevant documents, such as a human resources document regarding paid time off accrual or an employee handbook. These search results, as well as the prompt are used by the LLM to generate a response, in this example, “The company's paid time off is 12 days” based on the company's specific information, as recorded in the human resources document and the employee handbook. Thus, the LLM's performance is improved by utilizing search results obtained by the information retrieval system.

Note that FIG. 3 is just one example of a process, and other processes including fewer, additional, or alternative steps are possible consistent with this disclosure.

### Example Method of Adaptive Information Retrieval

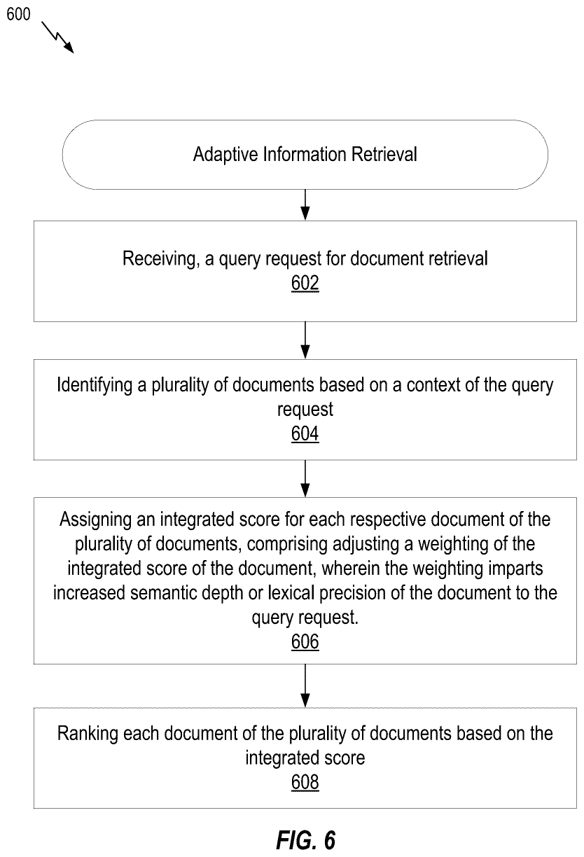

FIG. 6 depicts an example method 600 of adaptive information retrieval, for example, performed by information retrieval system 120 in FIG. 1.

Initially, the method 600 begins at step 602 with receiving, a query request for document retrieval, for example, a query received from user 102 in FIG. 1 or user 202 in FIG. 2. In some embodiments, the query request is received from an LLM, for example, LLM 122 in FIG. 1. For example, in some embodiments, the query request comprises a relevancy search, and the method 600 further comprises: generating, by a LLM, the relevancy search based on a prompt received by the LLM; and providing the one or more of the plurality of documents to the LLM to augment the prompt.

The method 600 proceeds to step 604 with identifying a plurality of documents based on a context of the query request, comprising: assigning a semantic score to each document of the plurality of documents based on a semantic relevance between the query request and each respective document, for example, as described with respect to semantic search component 108 in FIG. 2; and assigning a lexical score to each document of the plurality of documents based on a lexical relevance between the query request and each respective document, for example, as described with respect to lexical search component 110 in FIG. 2.

In some embodiments, the semantic relevance comprises a similarity between an embedding representing the query request and an embedding representing the respective document.

In some embodiments, the method 600 further comprises converting the query request to the embedding representing the query request; embedding the embedding representing the query request in a vector index comprising a plurality of embeddings, wherein each embedding of the plurality of embeddings is the embedding representing the respective document; and determining a similarity between the embedding representing the query request and each respective embedding of the plurality of embeddings, for example, as described with respect to FIG. 4.

In some embodiments, the lexical relevance comprises a keyword match between one or more keywords associated with each document and the one or more keywords associated with the query request.

In some embodiments, the method 600 further comprising: extracting the one or more keywords associated with the query request; searching an inverted index comprising a set of keywords, wherein each keyword in the set of keywords is associated with at least one document in the plurality of documents; and determining the keyword match based on the extracted one or more keywords and the inverted index, for example, as described with respect to FIG. 5.

The method 600 then proceeds to step 606 with assigning an integrated score for each respective document of the plurality of documents based on the semantic score for the respective document and the lexical score for the respective document, for example, as described with respect to the intelligent sensor and score calibrator component 104 in FIG. 2. In some embodiments, assigning the integrated score for each respective document of the plurality of documents based on the semantic score for the respective document and the lexical score for the respective document, comprises adjusting a weighting of the integrated score of the document, wherein the weighting imparts increased semantic depth or lexical precision of the document to the query request.

In some embodiments, assigning the integrated score for each respective document of the plurality of documents based on the semantic score for the respective document and the lexical score for the respective document, comprises adjusting a weighting of the semantic score of the respective document based on an index type associated with the query request.

In some embodiments, assigning the integrated score for each respective document of the plurality of documents based on the semantic score for the respective document and the lexical score for the respective document, comprises adjusting weighting of the lexical score of the respective document based on an index type associated with the query request.

The method 600 then proceeds to step 608 with ranking each document of the plurality of documents based on the integrated score, for example, as described with respect to the intelligent sensor and score calibrator component 104 in FIGS. 1 and 2.

In some embodiments, the method 600 further comprises identifying one or more of the plurality of documents satisfying a ranking threshold, comprising: for each respective document, comparing a respective ranking to a ranking threshold; determining the respective ranking for the respective document satisfies the ranking threshold; and identifying, the respective document as one of the one or more of the plurality of documents.

Beneficially, the method 600 may adjust the integrated score based on both the semantic search results and the lexical search results to complement one another and provide lexically precise and conceptually relevant search results for the user query. For example, the integrated score may be dynamically adapted to impart increased reliance on semantic results (e.g., the semantic score) or lexical results (e.g., the lexical score) based on the context of the user query. In some embodiments, beneficially, the integrated score may be adjusted based on additional data related to the user and/or the information retrieval system, such as previous queries, user attributes, domain-specific systems, and the like associated with the user and/or the system to promote increased contextual relevance or lexical accuracy of the integrated score. Thus, the information retrieval systems described herein provide improved search results with greater relevance to user queries.

Note that FIG. 6 is just one example of a method, and other methods including fewer, additional, or alternative steps are possible consistent with this disclosure.

### Example Method for Adaptive Information Retrieval for RAG-Based LLM Processing

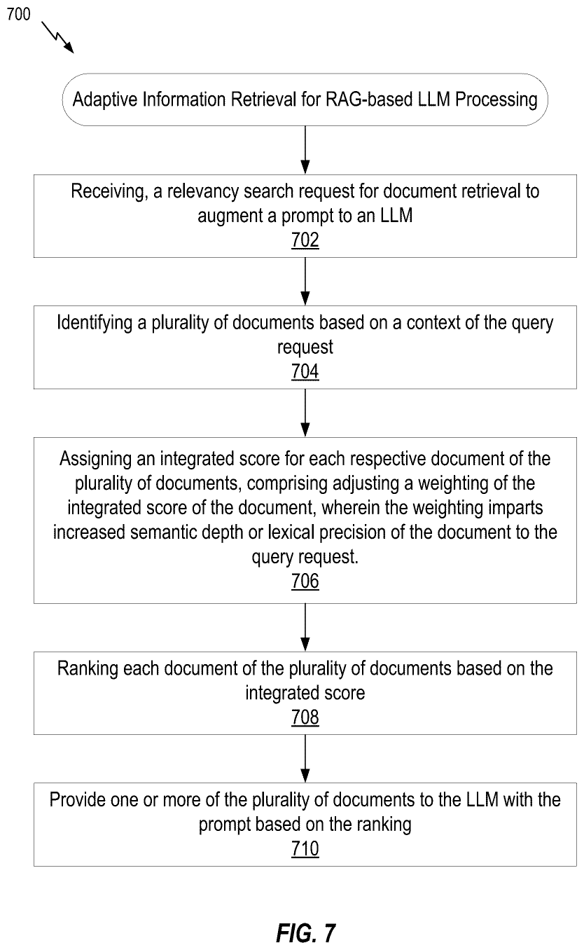

FIG. 7 depicts an example method 700 for adaptive information retrieval for RAG-based LLM processing, for example, with an information retrieval system 120 in FIG. 1

Initially, method 700 begins at step 702 with receiving, a relevancy search request for document retrieval to augment a prompt to a large language model (LLM) for example, LLM 122 in FIG. 1, such as for RAG-based LLM processing, described with respect to FIG. 3. In some embodiments, the relevancy search requests comprises a request for one or more documents for the prompt of the LLM.

Method 700 then proceeds to step 704 with identifying a plurality of documents based on a context of the relevancy search request, comprising: assigning a semantic score to each document of the plurality of documents based on a semantic relevance between the query request and each respective document, for example, as described with respect to semantic search component 108 in FIG. 2; and assigning a lexical score to each document of the plurality of documents based on a lexical relevance between the relevancy search request and each respective document, for example, as described with respect to lexical search component 110 in FIG. 2.

In some embodiments, the semantic relevance comprises a similarity between an embedding representing the relevancy search request and an embedding representing the respective document.

In some embodiments, method 700 further comprises converting the relevancy search request to the embedding representing the relevancy search request; embedding the embedding representing the relevancy search request in a vector index comprising a plurality of embeddings, wherein each embedding of the plurality of embeddings is the embedding representing the respective document; and determining a similarity between the embedding representing the relevancy search request and each respective embedding of the plurality of embeddings, for example, as described with respect to FIG. 4.

In some embodiments, the lexical relevance comprises a keyword match between one or more keywords associated with each document and the one or more keywords associated with the relevancy search request.

In some embodiments, method 700 further comprises extracting the one or more keywords associated with the relevancy search request; searching an inverted index comprising a set of keywords, wherein each keyword in the set of keywords is associated with at least one document in the plurality of documents; and determining the keyword match based on the extracted one or more keywords and the inverted index, for example, as described with respect to FIG. 5.

Method 700 then proceeds to step 706 with assigning an integrated score for each respective document of the plurality of documents based on the semantic score for the respective document and the lexical score for the respective document, for example, as described with respect to the intelligent sensor and score calibrator component 104 in FIG. 2.

In some embodiments, wherein assigning the integrated score for each respective document of the plurality of documents based on the semantic score for the respective document and the lexical score for the respective document, comprises adjusting a weighting of the semantic score of the respective document based on an index type associated with the relevancy search request.

In some embodiments, assigning the integrated score for each respective document of the plurality of documents based on the semantic score for the respective document and the lexical score for the respective document, comprises adjusting weighting of the lexical score of the respective document based on an index type associated with the relevancy search request.

In some embodiments, assigning the integrated score for each respective document of the plurality of documents based on the semantic score for the respective document and the lexical score for the respective document, comprises adjusting a weighting of the integrated score of the document, wherein the weighting imparts increased contextual relevance or lexical accuracy of the document to the relevancy search request.

Method 700 then proceeds to step 708 with ranking each document of the plurality of documents based on the integrated score.

Method 700 then proceeds to step 710 with providing one or more of the plurality of documents to the LLM with the prompt based on the ranking.

In some embodiments, method 700 further comprises identifying the one or more of the plurality of documents satisfying a ranking threshold, comprising: for each respective document, comparing a respective ranking to a ranking threshold; determining the respective ranking for the respective document satisfies the ranking threshold; and identifying, the respective document as one of the one or more of the plurality of documents.

Aspects of the adaptive information retrieval system described herein technical solutions and improvements of RAG methods by utilizing the improved information retrieval methods described herein to identify and obtain relevant additional data through the retrieval-based component of the LLM, and enhance generating of the output. Thereby, the LLM's performance may be improved through utilization of such supplemental data. Thus, embodiments described herein enable improved LLM responses and performance through improved information retrieval systems and methods to obtain such supplemental data for an LLM.

Note that FIG. 7 is just one example of a method, and other methods including fewer, additional, or alternative steps are possible consistent with this disclosure.

### Example Processing System for Information Retrieval

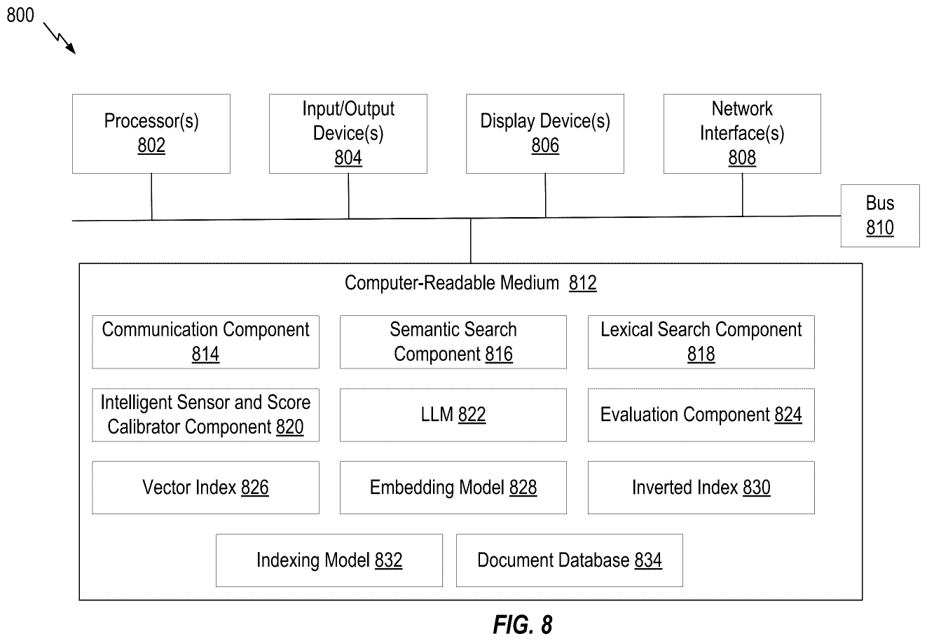

FIG. 8 depicts an example processing system 800 configured to perform various aspects described herein, including, for example, method 600 as described above with respect to FIG. 6, or method 700 as described with respect to FIG. 7.

Processing system 800 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 800 includes one or more processors 802, one or more input/output devices 804, one or more display devices 806, one or more network interfaces 808 through which processing system 800 is connected to one or more networks (e.g., a local network, an intranet, the Internet, or any other group of processing systems communicatively connected to each other), and computer-readable medium 812. In the depicted example, the aforementioned components are coupled by a bus 810, which may generally be configured for data exchange amongst the components. Bus 810 may be representative of multiple buses, while only one is depicted for simplicity.

Processor(s) 802 are generally configured to retrieve and execute instructions stored in one or more memories, including local memories like computer-readable medium 812, as well as remote memories and data stores. Similarly, processor(s) 802 are configured to store application data residing in local memories like the computer-readable medium 812, as well as remote memories and data stores. More generally, bus 810 is configured to transmit programming instructions and application data among the processor(s) 802, display device(s) 806, network interface(s) 808, and/or computer-readable medium 812. In certain embodiments, processor(s) 802 are representative of a one or more central processing units (CPUs), graphics processing unit (GPUs), tensor processing unit (TPUs), accelerators, and other processing devices.

Input/output device(s) 804 may include any device, mechanism, system, interactive display, and/or various other hardware and software components for communicating information between processing system 800 and a user of processing system 800. For example, input/output device(s) 804 may include input hardware, such as a keyboard, touch screen, button, microphone, speaker, and/or other device for receiving inputs from the user and sending outputs to the user.

Display device(s) 806 may generally include any sort of device configured to display data, information, graphics, user interface elements, and the like to a user. For example, display device(s) 806 may include internal and external displays such as an internal display of a tablet computer or an external display for a server computer or a projector. Display device(s) 806 may further include displays for devices, such as augmented, virtual, and/or extended reality devices. In various embodiments, display device(s) 806 may be configured to display a graphical user interface.

Network interface(s) 808 provide processing system 800 with access to external networks and thereby to external processing systems. Network interface(s) 808 can generally be any hardware and/or software capable of transmitting and/or receiving data via a wired or wireless network connection. Accordingly, network interface(s) 808 can include a communication transceiver for sending and/or receiving any wired and/or wireless communication.

Computer-readable medium 812 may be a volatile memory, such as a random access memory (RAM), or a nonvolatile memory, such as nonvolatile random access memory (NVRAM), or the like. In this example, computer-readable medium 812 includes a communication component 814, an LLM 822, a semantic search component 816, a vector index 826, an embedding model 828, a lexical search component 818, an inverted index 830, an indexing model 832, an intelligent sensor and score calibrator component 820, an evaluation component 824, and a document database 834.

In certain embodiments, the communication component 814 is configured to send and receive queries and responses, for example, query requests, relevancy search requests, search results, documents and interaction context, for example, as described with respect to step 602 in FIG. 6, and steps 702 and 710 in FIG. 7. In some embodiments, the communication component 814 is configured to send and receive queries and responses to an LLM 822, an example of LLM 122 in FIG. 1, and including retrieval-based component 322A and generative component 322B in FIG. 3.

In certain embodiments, the semantic search component 816 is configured to determine a semantic score for each document in a plurality of documents stored in the document database 834, for example, as described with respect to the semantic search component 108 in FIG. 2, step 604 in FIG. 6, and step 704 in FIG. 7. The semantic search component 816 may be further configured to utilize a vector index 826, an example of vector index 212 generated by an embedding model 828, an example of embedding model 420.

In certain embodiments, the lexical search component 818 is configured to determine a lexical score for each document in the plurality of documents stored in the document database 834, for example, as described with respect to the lexical search component 110 in FIG. 2, step 604 in FIG. 6, and step 704 in FIG. 7. The lexical search component 818 may be further configured to utilize an inverted index 830, an example of inverted index 214 generated by an indexing model 832, an example of indexing model 520.

In certain embodiments, the intelligent sensor and score calibrator component 820 is configured to assign an integrated score for each document in the plurality of documents stored in the document database 834, for example, as described with respect to intelligent sensor and score calibrator component 104 in FIG. 2, step 606 in FIG. 6, and step 706 in FIG. 7. The intelligent sensor and score calibrator component 820 is further configured to rank each document in the plurality of documents stored in the document database 834 based on the integrated score, for example, as described with respect to step 608 in FIG. 6 and step 708 in FIG. 7.

In certain embodiments, the evaluation component 824, an example of evaluation model 106 in FIG. 2, is configured to evaluate and dynamically adjust one or more hyperparameters of the intelligent sensor and score calibrator component, including weightings and biases, of an integrated score for each document of the plurality of documents stored in document databases 834.

Note that FIG. 8 is just one example of a processing system consistent with aspects described herein, and other processing systems having additional, alternative, or fewer components are possible consistent with this disclosure.

### Example Clauses

Implementation examples are described in the following numbered clauses:
Clause 1: A method of adaptive information retrieval, comprising: receiving, a query request for document retrieval; identifying a plurality of documents based on a context of the query request, comprising: assigning a semantic score to each respective document of the plurality of documents based on a semantic relevance between the query request and the respective document; and assigning a lexical score to each respective document of the plurality of documents based on a lexical relevance between the query request and the respective document; assigning an integrated score for each respective document of the plurality of documents based on the semantic score for the respective document and the lexical score for the respective document, comprising adjusting a weighting of the integrated score of the respective document, wherein the weighting imparts increased contextual relevance or lexical accuracy of the document to the query request; and ranking each document of the plurality of documents based on the integrated score.
Clause 2: The method of clause 1, further comprising identifying one or more of the plurality of documents satisfying a ranking threshold, comprising: for each respective document, comparing a respective ranking to the ranking threshold: determining the respective ranking for the respective document satisfies the ranking threshold; and identifying, the respective document as one of the one or more of the plurality of documents.
Clause 3: The method of clause 2, wherein the query request comprises a relevancy search, and the method further comprises: generating, by a large language model (LLM), the relevancy search based on a prompt received by the LLM; and providing the one or more of the plurality of documents to the LLM to augment the prompt.
Clause 4: The method of any one of clauses 1-3, wherein assigning the integrated score for each respective document of the plurality of documents based on the semantic score for the respective document and the lexical score for the respective document, comprises adjusting a weighting of the semantic score of the respective document based on an index type associated with the query request.
Clause 5: The method of any one of clauses 1-4, wherein assigning the integrated score for each respective document of the plurality of documents based on the semantic score for the respective document and the lexical score for the respective document, comprises adjusting weighting of the lexical score of the respective document based on an index type associated with the query request.
Clause 6: The method of any one of clauses 1-5, wherein the semantic relevance comprises a similarity between an embedding representing the query request and an embedding representing the respective document.
Clause 7: The method of clause 6, further comprising: converting the query request to the embedding representing the query request; embedding the embedding representing the query request in a vector index comprising a plurality of embeddings, wherein each embedding of the plurality of embeddings is the embedding representing the respective document; and determining a similarity between the embedding representing the query request and each respective embedding of the plurality of embeddings.
Clause 8: The method of any one of clauses 1-7, wherein the lexical relevance comprises a keyword match between one or more keywords associated with each document and the one or more keywords associated with the query request.
Clause 9: The method of clause 8, further comprising: extracting the one or more keywords associated with the query request; searching an inverted index comprising a set of keywords, wherein each keyword in the set of keywords is associated with at least one document in the plurality of documents; and determining the keyword match based on the extracted one or more keywords and the inverted index.
Clause 10: A method of adaptive information retrieval, comprising: receiving, a relevancy search request for document retrieval to augment a prompt to a large language model (LLM); identifying a plurality of documents based on a context of the relevancy search request, comprising: assigning a semantic score to each respective document of the plurality of documents based on a semantic relevance between the relevancy search request and the respective document; and assigning a lexical score to each respective document of the plurality of documents based on a lexical relevance between the relevancy search request and the respective document; assigning an integrated score for each respective document of the plurality of documents based on the semantic score for the respective document and the lexical score for the respective document, comprising adjusting a weighting of the integrated score of the respective document, wherein the weighting imparts increased contextual relevance or lexical accuracy of the document to the query request; ranking each document of the plurality of documents based on the integrated score; and providing one or more of the plurality of documents to the LLM with the prompt based on the ranking.
Clause 11: The method of clause 10, wherein the relevancy search request comprises a request for one or more documents for the prompt of the LLM.
Clause 12: The method of any one of clauses 10-11, further comprising identifying one or more of the plurality of documents satisfying a ranking threshold, comprising: for each respective document, comparing a respective ranking to the ranking threshold; determining the respective ranking for the respective document satisfies the ranking threshold; and identifying, the respective document as one of the one or more of the plurality of documents.
Clause 13: The method of any one of clauses 10-12, wherein assigning the integrated score for each respective document of the plurality of documents based on the semantic score for the respective document and the lexical score for the respective document, comprises adjusting a weighting of the semantic score of the respective document based on an index type associated with the relevancy search request.
Clause 14: The method of any one of clauses 10-13, wherein assigning the integrated score for each respective document of the plurality of documents based on the semantic score for the respective document and the lexical score for the respective document, comprises adjusting weighting of the lexical score of the respective document based on an index type associated with the relevancy search request.
Clause 15: The method of any one of clauses 10-14, wherein the semantic relevance comprises a similarity between an embedding representing the relevancy search request and an embedding representing the respective document.
Clause 16: The method of any one of clauses 15, further comprising: converting the relevancy search request to the embedding representing the relevancy search request; embedding the embedding representing the relevancy search request in a vector index comprising a plurality of embeddings, wherein each embedding of the plurality of embeddings is the embedding representing the respective document; and determining a similarity between the embedding representing the relevancy search request and each respective embedding of the plurality of embeddings.
Clause 17: The method of any one of clauses 10, wherein the lexical relevance comprises a keyword match between one or more keywords associated with each document and the one or more keywords associated with the relevancy search request.
Clause 18: The method of any one of clauses 17, further comprising: extracting the one or more keywords associated with the relevancy search request; searching an inverted index comprising a set of keywords, wherein each keyword in the set of keywords is associated with at least one document in the plurality of documents; and determining the keyword match based on the extracted one or more keywords and the inverted index.
Clause 19: A processing system, comprising: a memory comprising computer-executable instructions; and a processor configured to execute the computer-executable instructions and cause the processing system to perform a method in accordance with any one of Clauses 1-18.
Clause 20: A processing system, comprising means for performing a method in accordance with any one of Clauses 1-18.
Clause 21: A non-transitory computer-readable medium storing program code for causing a processing system to perform the steps of any one of Clauses 1-18.
Clause 22: A computer program product embodied on a computer-readable storage medium comprising code for performing a method in accordance with any one of Clauses 1-18.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method of adaptive information retrieval, comprising:
receiving, at an adaptive information retrieval system, a query request for document retrieval;
identifying a plurality of documents based on a context of the query request, comprising:
assigning a semantic score to each respective document of the plurality of documents based on a semantic relevance between the query request and the respective document; and
assigning a lexical score to each respective document of the plurality of documents based on a lexical relevance between the query request and the respective document;
assigning an integrated score for each respective document of the plurality of documents based on the semantic score for the respective document and the lexical score for the respective document, comprising:
adjusting a weighting of the integrated score of the respective document using an evaluation machine learning model, wherein the weighting imparts increased contextual relevance or lexical accuracy of the respective document to the query request; and
adjusting a weighting of the semantic score of the respective document based on an index type associated with the query request; and
ranking each document of the plurality of documents based on the integrated score.

2. The method of claim 1, further comprising identifying one or more of the plurality of documents satisfying a ranking threshold, comprising:
for each respective document, comparing a respective ranking to the ranking threshold:
determining the respective ranking for the respective document satisfies the ranking threshold; and
identifying the respective document as one of the one or more of the plurality of documents.

3. The method of claim 2, wherein the query request comprises a relevancy search, and the method further comprises:
generating, by a large language model (LLM), the relevancy search based on a prompt received by the LLM; and
providing the one or more of the plurality of documents to the LLM to augment the prompt.

4. (canceled)

5. The method of claim 1, wherein assigning the integrated score for each respective document of the plurality of documents based on the semantic score for the respective document and the lexical score for the respective document, comprises adjusting weighting of the lexical score of the respective document based on an index type associated with the query request.

6. The method of claim 1, wherein the semantic relevance comprises a similarity between an embedding representing the query request and an embedding representing the respective document.

7. The method of claim 6, further comprising:
converting the query request to the embedding representing the query request;
embedding the embedding representing the query request in a vector index comprising a plurality of embeddings, wherein each embedding of the plurality of embeddings is the embedding representing the respective document; and
determining a similarity between the embedding representing the query request and each respective embedding of the plurality of embeddings.

8. The method of claim 1, wherein the lexical relevance comprises a keyword match between one or more keywords associated with each document and the one or more keywords associated with the query request.

9. The method of claim 8, further comprising:
extracting the one or more keywords associated with the query request;
searching an inverted index comprising a set of keywords, wherein each keyword in the set of keywords is associated with at least one document in the plurality of documents; and
determining the keyword match based on the extracted one or more keywords and the inverted index.

10. A method of adaptive information retrieval, comprising:
receiving, a relevancy search request for document retrieval to augment a prompt to a large language model (LLM);
identifying a plurality of documents based on a context of the relevancy search request, comprising:
assigning a semantic score to each respective document of the plurality of documents based on a semantic relevance between the relevancy search request and the respective document; and
assigning a lexical score to each respective document of the plurality of documents based on a lexical relevance between the relevancy search request and the respective document;
assigning an integrated score for each respective document of the plurality of documents based on the semantic score for the respective document and the lexical score for the respective document, comprising:
adjusting a weighting of the integrated score of the respective document using an evaluation machine learning model, wherein the weighting imparts increased contextual relevance or lexical accuracy of the respective document to the relevancy search request; and
adjusting a weighting of the semantic score of the respective document based on an index type associated with the relevancy search request;
ranking each document of the plurality of documents based on the integrated score; and
providing one or more of the plurality of documents to the LLM with the prompt based on a respective ranking of each of the one or more plurality of documents.

11. The method of claim 10, wherein the relevancy search request comprises a request for one or more documents for the prompt of the LLM.

12. The method of claim 10, further comprising identifying one or more of the plurality of documents satisfying a ranking threshold, comprising:
for each respective document, comparing a respective ranking to the ranking threshold;
determining the respective ranking for the respective document satisfies the ranking threshold; and
identifying, the respective document as one of the one or more of the plurality of documents.

13. (canceled)

14. The method of claim 10, wherein assigning the integrated score for each respective document of the plurality of documents based on the semantic score for the respective document and the lexical score for the respective document, comprises adjusting weighting of the lexical score of the respective document based on an index type associated with the relevancy search request.

15. The method of claim 10, wherein the semantic relevance comprises a similarity between an embedding representing the relevancy search request and an embedding representing the respective document.

16. The method of claim 15, further comprising:
converting the relevancy search request to the embedding representing the relevancy search request;
embedding the embedding representing the relevancy search request in a vector index comprising a plurality of embeddings, wherein each embedding of the plurality of embeddings is the embedding representing the respective document; and
determining a similarity between the embedding representing the relevancy search request and each respective embedding of the plurality of embeddings.

17. The method of claim 10, wherein the lexical relevance comprises a keyword match between one or more keywords associated with each document and the one or more keywords associated with the relevancy search request.

18. The method of claim 17, further comprising:
extracting the one or more keywords associated with the relevancy search request;
searching an inverted index comprising a set of keywords, wherein each keyword in the set of keywords is associated with at least one document in the plurality of documents; and
determining the keyword match based on the extracted one or more keywords and the inverted index.

19. An adaptive information retrieval system, comprising: a memory comprising computer-executable instructions; and a processor configured to execute the computer-executable instructions and cause the adaptive information retrieval system to:
receive, at the adaptive information retrieval system, a query request for document retrieval;
identify a plurality of documents based on a context of the query request, wherein to identify the plurality of documents comprises to:
assign a semantic score to each respective document of the plurality of documents based on a semantic relevance between the query request and the respective document; and
assign a lexical score to each respective document of the plurality of documents based on a lexical relevance between the query request and the respective document;
assign an integrated score for each respective document of the plurality of documents based on the semantic score for the respective document and the lexical score for the respective document, comprising:
adjusting a weighting of the integrated score of the respective document using an evaluation machine learning model, wherein the weighting imparts increased contextual relevance or lexical accuracy of the respective document to the query request; and
adjusting a weighting of the semantic score of the respective document based on an index type associated with the query request; and
rank each document of the plurality of documents based on the integrated score.

20. (canceled)

21. The method of claim 1, wherein adjusting the weighting of the integrated score of the respective document, comprises tuning the weighting of the integrated score based on user feedback.

22. The method of claim 12, wherein the ranking threshold is based on a size of a context window of the LLM.

23. The method of claim 1, further comprising providing, in response to the query request, a set of documents of the plurality of documents based on the ranking.
